(19) United States
(12) Patent Application Publication
(10) Pub. No.: US 2018/0044076 A1
(43) Pub. Date: Feb. 15, 2018

(54) MEDICINAL VIAL STOPPER

(71) Applicant: West Pharmaceutical Services, Inc., Exton, PA (US)

(72) Inventor: Christian EICHHORN, Pottstown, PA (US)

(21) Appl. No.: 15/559,567

(22) PCT Filed: Mar. 23, 2015
(86) PCT No.: PCT/US15/22038

§ 371 Date: Sep. 19, 2017

(51) Int. Cl. B65D 51/00; A61J 1/14

(52) U.S. Cl. CPC B65D 51/002; A61J 1/1406; A61J 1/1425

(57) ABSTRACT

A medicinal vial stopper has a stopper plug extending from a stopper flange. The stopper plug is insertable with a compression fit in the neck of the vial. A first bore within the stopper plug has a radially inwardly facing first-bore surface having a constant first-bore diameter the entire first-bore length and a first-bore first end closed by a centrally-located piercable portion of the stopper flange. A second bore within the stopper plug has a radially inwardly facing second-bore surface having a constant second-bore diameter the entire second-bore length. The second-bore diameter is greater the first-bore diameter. The second-bore first end is in fluid communication with the first-bore second end. The centrally-located piercable portion of the stopper flange is resiliently deformable and upon being pierced by a spike tightly conforms to the radially outwardly facing sidewall of the shaft; thereby forming a fluid impenetrable seal.

### BACKGROUND OF THE INVENTION

The present invention relates to stoppers for medicinal vessels. More particularly, the present invention relates to a medicinal vial stopper which can be penetrated by a puncturing device, for example a syringe needle or vial adapter, and is self-closing upon withdrawal of the puncturing device.

Drugs intended for parenteral administration can be stored in a medicinal vial as a dry powder which requires reconstitution in the vial with a physiological solution, such as a sterile solution of sodium chloride that is isotonic to body fluids, prior to withdrawal of the reconstituted drug from the vial. Solutions which are ready for immediate use or in the form of a liquid concentrate which requires reconstitution are also stored in medicinal vials. Regardless of the manner in which a drug is stored, there is a need to transfer the liquid from of the drug in a medicinal vial to a dispensing device.

Referring to FIG. 1, an inverted portion of a typical medicinal vial 10 from which a medicament has been withdrawn is shown. The vial 10 has a neck 12 with an open end 12a circumscribed by a neck flange 14 having a generally annular shape.

A conventional stopper 20 having a stopper flange 22 from which a stopper plug 24 extends is sealingly inserted in the neck 12 of the medicinal vial 10. The stopper plug 24 has a generally cylindrical-shape cavity (or headspace) 26 with one end closed by the centrally located piercable portion of the stopper flange 22 and the other end in open fluid communication with the contents of the vial 10.

A vial adapter 30 having a top wall 32 from which a generally cylindrical skirt 34 extends is attached to the vial 10 by a neck grip 36 which extends radially inwardly from the skirt 34 and engages the flange 14 of the bottle in a snap fit. A hub 38 attachable to a syringe barrel (not shown) extends from one side of the top wall 32. A spike 40 extends from the other side of the top wall 32. The spike 40 has a shaft 42 which pierces a central portion of the stopper flange 22. The shaft 42 has a radially outwardly facing sidewall 44. A lumen 46 within the shaft 42 is in fluid communication with the hub 38 and has at least one vent 48 proximal the tip 50 of the shaft 42 through which the medicament may be drawn into the lumen 44. A ride-up 28 of the stopper flange 22 extends along a portion of the sidewall 44 of the shaft 42 after the shaft 42 has pierced the stopper flange 22.

In conventional practice, the medicament is withdrawn from the vial by inverting the vial as shown in FIG. 1 after the stopper flange 22 has been pierced and the shaft 42 inserted into the vial 10 until the vent 48 is past the ride-up 28 and the medicament can be withdrawn by a dispending device (not shown) attachable to the hub 38. Due to the ride-up 28 and the diameter of the closed end of the headspace 26, the medicament is usually not completely withdrawn from the vial 10. For example, for a conventional 13 millimeter-size stopper, the residual amount of medicament remaining in the vial is typically 0.14 milliliters; for a conventional 20 millimeter-size stopper , the residual amount of medicament remaining in the vial is typically 0.25 milliliters.

Accordingly, in view of the ever increasing cost of medicament, there is a need in the art for a medicinal vial stopper which reduces the residual amount of medicament that can not be withdrawn from a vial.

### BRIEF SUMMARY OF THE INVENTION

Briefly stated, one embodiment of the present invention is directed to a vial stopper for sealing an open end of a neck of a vial containing a medicament withdrawable from the vial by a spike able to pierce the stopper. A neck flange circumscribes the open end of the vial and has a generally annular shape. The spike comprises a shaft having a radially outwardly facing sidewall with a diameter. A lumen within the shaft has at least one vent proximal to a tip of the shaft through which the medicament may be drawn into the lumen.

The vial stopper comprises a stopper flange having a circular disk-like shape with a stopper-flange outer diameter bisected by a stopper flange longitudinal axis and a flange thickness in a direction parallel to the longitudinal axis. The stopper flange has a first side, a second side spaced the flange thickness from the first side and a centrally-located stopper-flange portion piercable by the spike.

A stopper plug extends from the second side of the stopper flange. The stopper plug has a circular cylindrical shape with a plug outer diameter bisected by the flange longitudinal axis and less than the stopper-flange outer diameter. The stopper plug is insertable with a compression fit in the neck of the vial.

A first bore is within the stopper plug. The first bore has a first-bore first end and a first-bore second end a first-bore length from the first-bore first end. A radially inwardly facing first-bore surface has a constant first-bore diameter the entire first-bore length. The first-bore first end is closed by the centrally-located piercable portion of the stopper flange.

A second bore is within the stopper plug. The second bore has a second-bore first end and a second-bore second end a second-bore length from the second-bore first end. A radially inwardly facing second-bore surface has a constant second-bore diameter the entire second-bore length. The second-bore diameter is greater than the first-bore diameter. The second-bore first end is in fluid communication with the first-bore second end.

The centrally-located piercable portion of the stopper flange is resiliently deformable and upon being pierced by the spike tightly conforms to the radially outwardly facing sidewall of the shaft; thereby forming a fluid impenetrable seal.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, the drawings show embodiments which are presently preferred. It should be understood, however, that the invention is not limited to the precise arrangements and instrumentalities shown.

In the drawings:

FIG. 1 is a cross sectional view of a portion of an inverted vial sealed by a prior art stopper penetrated by a conventional vial adapter;

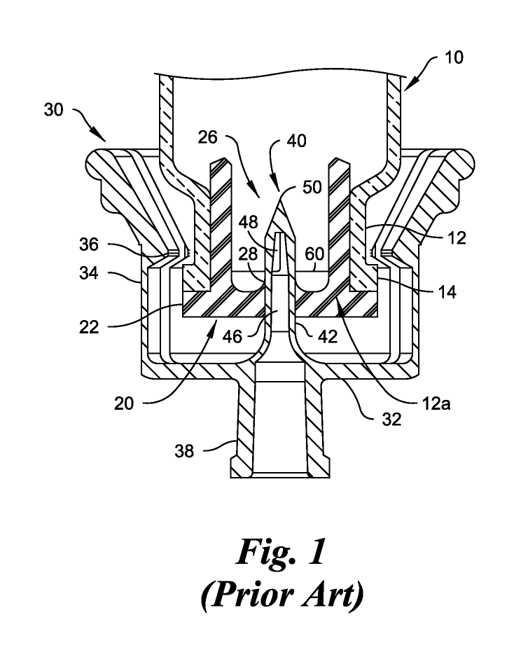

FIG. 2 is a cross sectional view of a first preferred embodiment of vial stopper in accordance with the present invention spaced from a cross sectional view of a portion of the spike of the vial adapter of FIG. 1;

FIG. 3 is a cross sectional view of a portion of an inverted vial sealed by the stopper penetrated of FIG. 2 penetrated by the conventional vial adapter of FIG. 1; and

FIG. 4 is an enlarged portion of FIG. 3 showing the ride-up of the stopper flange extends along a portion of the sidewall of the shaft after the shaft has pierced the stopper flange.

### DETAILED DESCRIPTION OF THE INVENTION

Reference will now he made in detail to embodiments of the invention, examples of which are illustrated in the accompanying drawings. The terminology used in the description of the invention herein is for the purpose of describing particular embodiments only and is not intended to be limiting of the invention.

As used in the description of the invention and the appended claims, the singular forms “a”, “an” and “the” are intended to include the plural forms as well, unless the context clearly indicates otherwise. The words “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although the words first, second, etc., are used herein to describe various elements, these elements should not be limited by these words. These words are only used to distinguish one element from another. For example, a first bore could be termed a second bore, and, similarly, a second bore could be termed a first bore, without departing from the scope of the present invention.

The following description is directed towards various embodiments of a medicinal stopper vial in accordance with the present invention.

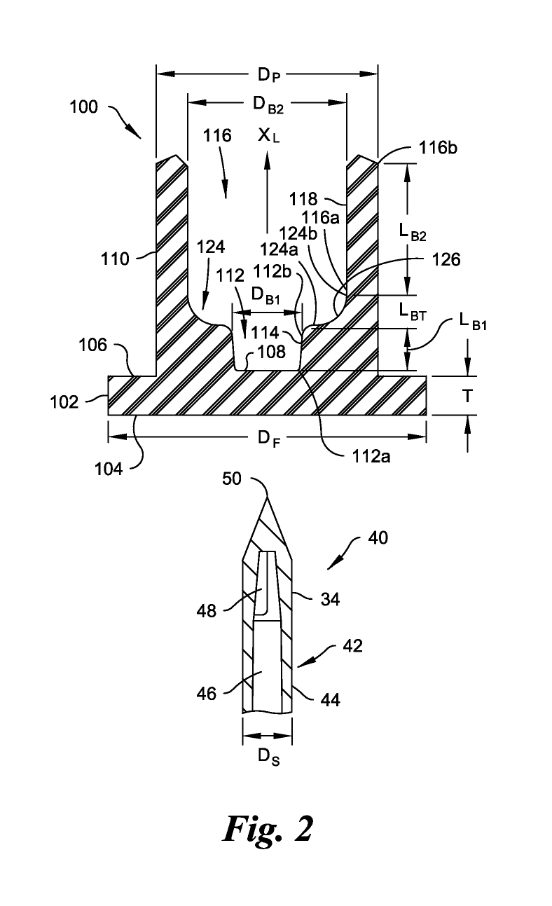

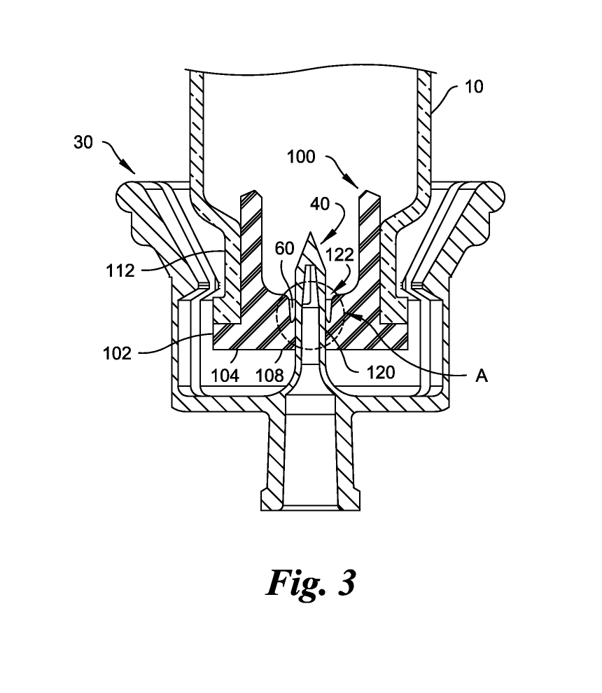

Referring to the drawings in detail, where like numerals indicate like elements throughout, there is shown in FIGS. 2-4 a first preferred embodiment of the medicinal vial stopper, generally designated 100, and hereinafter referred to as the “vial stopper” 100 in accordance with the present invention. The vial stopper 100 is for sealing an open end 12a of a neck 12 of a vial 10 containing a medicament withdrawable from the vial by a spike 40 able to pierce the stopper. A neck flange 14 circumscribes the open end 12a of the vial 10 and has a generally annular shape. The spike 40 comprises a shaft 42 having a radially outwardly facing sidewall 44 with a diameter D_{S}. A lumen 46 within the shaft 42 has at least one vent 48 proximal to a tip 50 of the shaft 42. The medicament may be drawn into the lumen 46 through the vent 48.

The vent stopper 100 comprises a stopper flange 102 having a circular disk-like shape with a stopper-flange outer diameter D_{F} bisected by a stopper flange longitudinal axis “X_{L}” and a flange thickness “T” in a direction parallel to the longitudinal axis X_{L}. The stopper flange 102 has a first side 104, a second side 106 spaced the flange thickness “T” from the first side 104 and a centrally-located stopper-flange portion 108 piercable by the spike 40;

A stopper plug 110 extends from the second side 106 of the stopper flange 102. The stopper plug 110 has a circular cylindrical shape with a plug outer diameter D_{P} bisected by the flange longitudinal axis X_{L} and less than the stopper-flange outer diameter D_{F}. The stopper plug 110 is sealingly insertable with a compression fit in the neck 12 of the vial 10.

A first bore 112 is within the stopper plug 110. The first bore 112 has a first-bore first end 112a and a first-bore second end 112b a first-bore length L_{B1} from the first-bore first end 112a. A radially inwardly facing first-bore surface 114 has a constant first-bore diameter D_{B1} the entire first-bore length L_{B1}. The first-bore first end 112a is closed by the centrally-located piercable portion 108 of the stopper flange 102.

In some embodiments of the vial stopper 100, the radially inwardly facing first-bore surface 114 of the first bore 112 is in sliding contact with the outer surface 44 of the shaft 42 after the spike 40 has pierced the centrally-located piercable portion 108 of the stopper flange 102 and is being inserted beyond the second end 112b of the first bore 112.

In other embodiments, a volume of an annular space 122 bounded by the radially inwardly facing first-bore surface 114 and a portion of the outer surface 44 of the shaft 42 opposing the radially inwardly facing first-bore surface 114 is desirably more than about 0.01 milliliter and less than about 0.25 milliliter and preferably less than about 0.20 milliliter when the spike 40 has pierced the centrally-located piercable portion 108 of the stopper flange 102 and is inserted beyond the second end 112b of the first bore 112 and the radially inwardly facing first-bore surface 114 is spaced from the outer surface of the shaft 42.

In still other embodiments of the vial stopper 100, the volume of an annular space 122 bounded by the radially inwardly facing first-bore surface 11.4 and a portion of the outer surface 44 of the shaft 42 opposing the radially inwardly facing first-bore surface 114 is desirably more than about 0.01 milliliter and less than about 0.14 milliliter and preferably less than about 0.10 milliliters when the spike 40 has pierced the centrally-located piercable portion 108 of the stopper flange 102 and is inserted beyond the second end 112b of the first bore 112 and the radially inwardly facing first-bore surface 114 is spaced from the outer surface of the shaft 42.

A second bore 116 is within the stopper plug 110. The second bore 116 has a second-bore first end 116a and a second-bore second end 116b a second-bore length L_{B2} from the second-bore first end 116a. A radially inwardly facing second-bore surface 118 has a constant second-bore diameter D_{B2} the entire second-bore length L_{B2}. The second-bore diameter D_{B2} is greater than the first-bore diameter D_{B1} The second-bore first end 116a is in fluid communication with the first-bore second end.

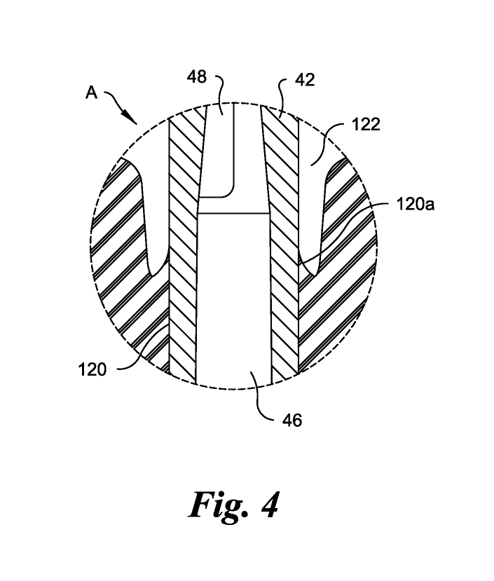

The centrally-located piercable portion 108 of the stopper flange 102 is resiliently deformable and upon being pierced by the spike 40 tightly conforms to the radially outwardly facing sidewall 44 of the shaft 42, thereby forming a fluid impenetrable seal 120. In some embodiments, the fluid impenetrable seal 120 has a run-up 120a comprising edges of the centrally-located piercable portion 108 of the stopper flange 102 formed when the centrally-located piercable portion 108 of the stopper flange 102 is pierced by the spike 40 and extending along the outwardly facing side wall of the shaft 42 as shown in FIG. 4.

Preferably, the vial stopper 100 has a transition bore 124 between the first bore 112 and the second bore 116.

In some embodiments of the vial stopper 100 has a transition bore 124 having a transition-bore first end 124a and a transition-bore second end 124b a transition-bore length L_{BT} from the transition-bore first end 124a between the first bore 112 and the second bore 116. The transition-bore first end 124a has a transition-bore first-end diameter equal to the first-bore diameter D_{BI}. The transition-bore second end 124b having a transition-bore second-end diameter equal to the second-bore diameter D_{B2}. The transition bore 124 has a radially inwardly facing transition-bore surface 126 having an arcuate shape. Alternatively, the radially inwardly facing transition-bore surface 126 may have a shape corresponding to an inner surface of a truncated frustum of a hollow cone.

In a preferred embodiment of the vial stopper 100, the transition bore 124 comprises an annular surface 126 lying entirely in a plane perpendicular to the longitudinal axis X_{L} of the stopper flange 102 and has a transition-bore inner diameter equal to the first-bore diameter D_{B1} and a transition-bore outer diameter equal to the second-bore diameter D_{B2}.

The foregoing detailed description of the invention has been disclosed with reference to specific embodiments. However, the disclosure is not intended to be exhaustive or to limit the invention to the precise forms disclosed. Those skilled in the art will appreciate that changes could be made to the embodiments described above without departing from the broad inventive concept thereof. Therefore, the disclosure is intended to cover modifications within the spirit and scope of the present invention as defined by the appended claims.

We claim:

1. A vial stopper for sealing an open end of a neck of a vial containing a medicament withdrawable from the vial by a spike able to pierce the stopper, a neck flange circumscribing the open end and having a generally annular shape, the spike comprising a shaft having a radially outwardly facing sidewall with a diameter D_{S}, a lumen within the shaft having at least one vent proximal to a tip of the shaft and through which the medicament may be drawn into the lumen, the vial stopper 100 comprising:
a stopper flange having a circular disk-like shape with a stopper-flange outer diameter D_{F} bisected by a stopper flange longitudinal axis “X_{L}” and a flange thickness “T” in a direction parallel to the longitudinal axis X_{L}, the stopper flange having a first side 1, a second side spaced the flange thickness from the first side and a centrally-located stopper-flange portion piercable by the spike;
a stopper plug extending from the second side of the stopper flange, the stopper plug having a circular cylindrical shape with a plug outer diameter D_{P} bisected by the flange longitudinal axis X_{L} and less than the stopper-flange outer diameter D_{F}, the stopper plug sealingly insertable with a compression fit in the neck of the via;
a first bore within the stopper plug, the first bore having a first-bore first end and a first-bore second en a first-bore length from the first-bore first end, a radially inwardly facing first-bore surface having a constant first-bore diameter D_{B1} the entire first-bore length, the first-bore first closed by the centrally-located piercable portion of the stopper flange;
a second bore within the stopper plug, the second bore having a second-bore first end and a second-bore second en a second-bore length from the second-bore first end, a radially inwardly facing second-bore surface having a constant second-bore diameter D_{B2} the entire second-bore length, the second-bore diameter D_{B2} greater than the first-bore diameter D_{B1}, the second-bore first end in fluid communication with the first-bore second end,
wherein the centrally-located piercable portion of the stopper flange is resiliently deformable and upon being pierced by the spike tightly conforms to the radially outwardly facing sidewall of the shaft thereby forming a fluid impenetrable seal.

2. The vial stopper according to claim 1, wherein radially inwardly facing first-bore surface is in sliding contact with the outer surface of the shaft after the spike has pierced the centrally-located piercable portion 108 of the stopper flange and is being inserted beyond the second end of the first bore.

3. The vial stopper according to claim 1, wherein a volume of an annular space bounded by the radially inwardly facing first-bore surface and an portion of the outer surface of the shaft opposing the radially inwardly facing first-bore surface is more than about 0.01 milliliter and less than about 0.25 milliliter when the spike has pierced the centrally-located piercable portion of the stopper flange and is inserted beyond the second end of the first bore and the radially inwardly facing first-bore surface is spaced from the outer surface of the shaft.

4. The vial stopper according to claim 1, wherein a volume of an annular space bounded by the radially inwardly facing first-bore surface and an portion of the outer surface of the shaft opposing the radially inwardly facing first-bore surface is more than about 0.01 milliliter and less than about 0.14 milliliter when the spike has pierced the centrally-located piercable portion of the stopper flange and extends beyond the second end of the first bore and the radially inwardly facing first-bore surface is spaced from the outer surface of the shaft.

5. The vial stopper according to claim 1, wherein a transition bore is between the first bore and the second bore, the bore transition being an annular surface lying entirely in a plane perpendicular to the longitudinal axis of the stopper flange and having a transition-bore inner diameter equal to the first-bore diameter D_{B1} and a transition-bore outer diameter equal to the second-bore diameter D_{B2}.

6. The vial stopper according to claim 1, wherein a transition bore is between the first bore and the second bore, the bore transition having a transition-bore first end and a transition-bore second end a transition-bore length from the transition-bore first end, the transition-bore first end having a transition-bore first-end diameter equal to the first-bore diameter D_{B1}, the transition-bore second end having a transition-bore second-end diameter equal to the second-bore diameter DB2, and a radially inwardly facing transition-bore surface has a shape corresponding to an inner surface of a truncated frustum of a hollow cone.

7. The vial stopper according to claim 1, wherein the bore has a transition bore between the first bore and the second bore, the bore transition having a transition-bore first end 124a and a transition-bore second end 124b a transition-bore length from the transition-bore first end 124a, the transition-bore first end 124a having a transition-bore first-end diameter equal to the first-bore diameter D_{B1} the transition-bore second end 124b having a transition-bore second-end diameter equal to the second-bore diameter DB2, and a radially inwardly facing transition-bore surface 126 has an arcuate shape.

8. The vial stopper according to claim 1, wherein the fluid impenetrable seal 120 comprises ruptured edges of the centrally-located piercable portion 108 of the stopper flange 102 formed when the centrally-located piercable portion 108 of the stopper flange 102 is pierced by the spike 20.

9. The vial stopper according to claim 1, wherein the stopper is a lyophilization stopper.

10. A vial 10 containing a medicament withdrawable from the vial by a spike 20 able to pierce the vial stopper 100 according to claim 1 sealing an open end 12a of a neck 12 of the vial 10.
